(19) United States
(12) Patent Application Publication
(10) Pub. No.: US 2008/0244153 A1
(43) Pub. Date: Oct. 2, 2008

(54) CACHE SYSTEMS, COMPUTER SYSTEMS AND OPERATING METHODS THEREOF

(75) Inventor: Tauli Huang, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/695,121

(22) Filed: Apr. 2, 2007

(51) Int. Cl. G06F 12/00

(52) U.S. Cl. 711/3

(57) ABSTRACT

Cache systems, computer systems and methods thereof are disclosed. A buffer buffers first data from a main memory prior to writing to the cache memory. In response to a cache hit, a word from the cache memory is read. In response to a cache miss, the first data is written from the buffer to the cache memory. When the cache hit occurs before all first data is written from the buffer to the cache memory, the reading is executed and the writing is paused.

### BACKGROUND OF THE INVENTION

1. Field of the Invention

The invention relates to cache systems and in particular to cache systems managing cache hits when cache update for a previous cache miss is not complete.

2. Description of the Related Art

A cache memory is a high-speed memory unit interposed between a processor and a slower main memory in a computer system. Typically, a cache memory stores a copy of data recently used by the processor to shorten average memory data latency and improve overall system performance. A cache memory is usually implemented by semiconductor memory devices having speeds comparable to the speed of the processor, while the main memory utilizes a less costly, lower speed technology. The cache memory can be, for example, a SRAM, and the main memory (also referred to as a system memory) a DRAM or flash memory.

The minimum amount of data that a cache memory stores is a block or a line of two or more words. Each line in the cache memory is associated with an address tag used to identify the address of the line with respect to the main memory. The address tags are typically included in a tag array memory device. Additional bits may further be stored for each line along with a corresponding address tag to identify the coherency state of the line.

A process may read from or write to one or more lines in the cache memory if the lines are present in the cache memory and if the coherency state allows the access. For example, when a processor requests a word, whether instruction or data, an address tag comparison is first made to determine whether a valid copy of the requested word is present in one line of the cache memory. If the line exists, a cache hit occurs and the copy is read or used directly from the cache memory. If the line is not present, a cache miss occurs and a line containing the requested word is retrieved from the main memory and may be written to update the cache memory. The requested word in the retrieved line is simultaneously supplied to the processor to satisfy the request.

A subsequent cache hit may occur when the cache update for a preceding cash miss is not complete. As described, the operating speed of the main memory is slower than that of the cache memory. The requested word may have been supplied from a main memory to the processor but the cache memory continues updating the rest of the retrieved line due to the data latency of the main memory. If a cache hit subsequently occurs when the entire retrieved line has not been written to the cache memory, the cache system is compromised by having to manage a read request and a write request at the same time.

A dual port cache memory, having two independent I/O ports, can service two read/write requests, irrespective of whether or not they occur simultaneously, but this measure is costly and burdensome due to a required silicon area typically 50%-100% times that of a single port cache memory.

### BRIEF SUMMARY OF THE INVENTION

The invention provides a cache memory system. A cache memory is coupled to a cache controller for storing lines. A buffer buffers first data from a main memory prior to updating the cache memory. The cache controller is configured to allow a processor to read the cache memory in response to a cache hit before cache update of the cache memory for a previous cache miss is complete. The buffer stores no address information of the first data.

One embodiment of the invention provides a method of operating a cache system with a cache memory. A buffer is used to buffer first data from a main memory prior to writing to the cache memory. In response to a cache hit, a word from the cache memory is read. In response to a cache miss, the first data is written from the buffer to the cache memory. When the cache hit occurs before the writing of all first data from the buffer to the cache memory is complete, the reading is executed and the writing paused.

The invention further provides a computer system. A cache controller is coupled to a processor. A cache memory is coupled to the cache controller, storing lines of words. A buffer buffers first data from a main memory prior to writing to the cache memory. The cache controller is configured to direct the processor to read the cache memory in response to a cache hit, and write the first data from the buffer to the cache memory in response to a cache miss. The cache controller is further configured to pause writing and execute reading when the cache hit occurs before all first data is written from the buffer to the cache memory.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a computer system according to one embodiment of the invention;

FIG. 2 exemplifies the computer system in FIG. 1;

FIG. 3 is a flowchart of operation of the computer system in FIG. 2; and

FIG. 4 details the operations for a cache miss according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

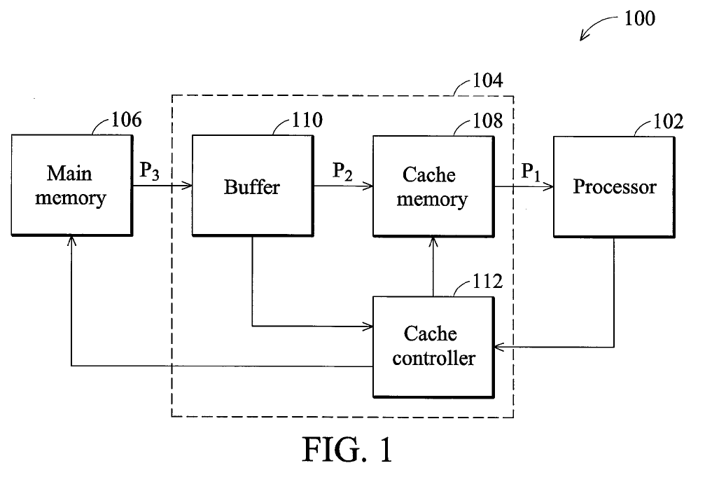

FIG. 1 is a block diagram of a computer system 100 according to one embodiment of the invention, substantially showing the data paths therein. In computer system 100, cache system 104 is interposed between processor 102 and main memory 106 to shorten data latency. In response to a read request from processor 102, cache controller 112 first determines whether a valid copy of the word requested by processor 102 is present in one line of cache memory 108, i.e., whether a cache hit or a cache miss occurs. Accordingly, cache controller 112 retrieves the required data from cache memory 108 or main memory 106 for processor 102. For a cache hit, a valid copy of the requested word is retrieved from cache memory 108 such that the data path for the requested data to processor 102 has only path P₁. For a cache miss, cache controller 112 retrieves the line containing the requested word from main memory 106 and sends it to cache memory 108 through buffer 110 for cache update. Simultaneously, the requested word in the line is also fed to processor 102 to fulfill the request. Thus, the data path for a cache miss comprises path P₃, path P₂ and path P₁ sequentially.

If a subsequent cache hit occurs when the cache update for a preceding cache miss has not yet been completed, data transmission on path P₂ is paused or terminated, the retrieved line remains buffered in buffer 110, and the I/O port of cache memory 108 becomes available for processor 102 to access the required word therefrom, as requested by the subsequent cache hit. After the subsequent cache hit has been satisfied or interrupted, the data transmission on path P₂ is resumed or allowed to approach the completion of the cache update to cache memory 108. Cache controller 112 is configured to prioritize a cache memory read higher than a, cache memory write request if conflict occurs, and to buffer the retrieved line for a preceding cache miss in buffer 106 when the cache update is not yet complete. Buffer 110 may store no address information of the buffered data because the address information is already known or can be easily derived by cache controller 112.

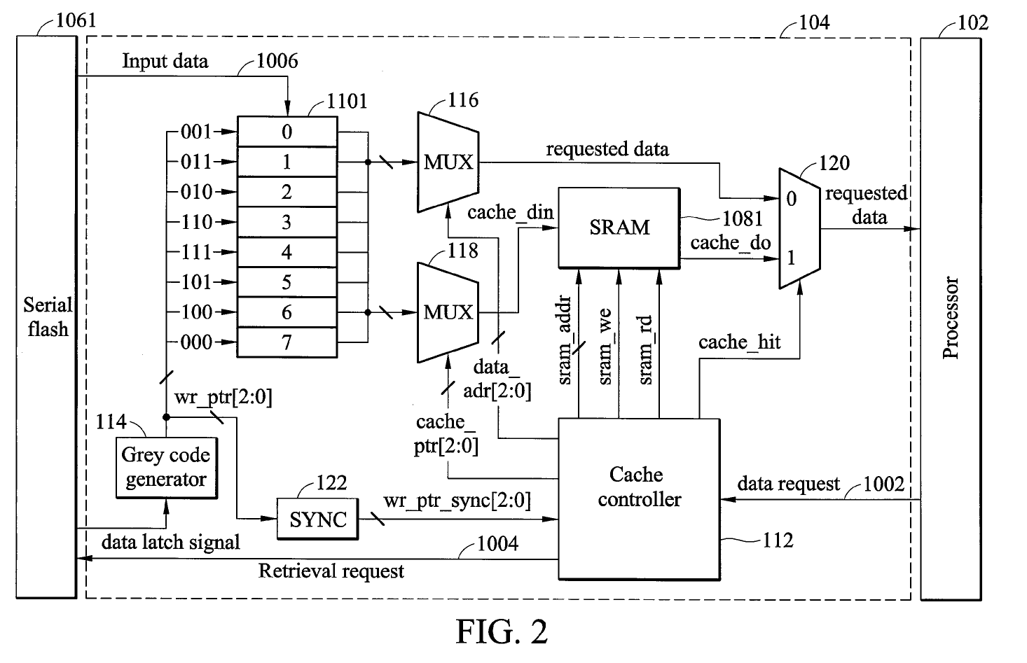

Computer system 100 in FIG. 1 is exemplified in FIG. 2, in which one-port SRAM 1081 embodies a cache memory, serial flash 1061 a main memory, and an 8-word asynchronous FIFO 1101 a buffer. In FIG. 2, a line has 8 words.

If a data request 1002 originates in processor 102 for a new word, cache controller 112 performs an address tag comparison to determine if a cache hit or a cache miss occurs. Upon a cache hit, cache controller 112 signals to one-port SRAM 1081 both a SRAM read request (sram_rd) and the address of the requested word inside one-port SRAM 1081 (sram_addr), such that the requested word is forwarded to processor 102 via switched multiplexer 120. On the other hand, upon a cache miss, cache controller 112 may send a retrieval request 1004 to serial flash 1061 to retrieve a line containing the requested word. Accordingly, the retrieved line, as input data 1006, is sequentially transmitted from serial flash 1061 to FIFO 1101. The write pointer, wr_ptr[2:0], provides cache controller 112 the status of FIFO 1101 such that cache controller 112 can determine whether the requested word and/or the retrieved line has been buffered in FIFO 1101. Once the occurrence of the requested word is acknowledged, cache controller 112 transmits data address data_adr[2:0], to switch multiplexers 116 for word selection, such that the requested word in FIFO 1101 is selected and sent to processor 102 through switched multiplexer 116, satisfying the request from processor 102. For cache update, upon confirmation that the retrieved line containing the requested word is ready in FIFO 1101, cache controller 112 converts one-port SRAM 1081 to a writeable condition by signaling out a SRAM write enable (sram_we), informing one-port SRAM 1081 where to update by sending, signal sram_addr, and then sequentially selecting words in the retrieved line in FIFO 1101 by switching multiplexer 118 to perform the cache update.

Grey codes from grey code generator 114 are used to address FIFO 1101, preventing cache controller 112 from misreading the write pointer, wr_ptr[2:0]. As FIFO 1101 is asynchronous, the write and read pointers thereof are allowed to operate at different clock frequencies. As shown in FIG. 2, read operation of FIFO 1101 is determined by multiplexers 116 and 118, both under the control of cache controller 112, while write operation of FIFO 1101 is controlled by the data latch signal from serial flash 1061 working at a lower clock frequency in comparison with that for cache controller 112. By using grey codes, in which only one bit is different between two consecutive grey codes, either a new write pointer or an old write pointer is propagated to and recognized by cache controller 112, such that misreading of the write pointer is avoided. Synchronization unit 122 converts the write pointer from the clock domain of serial flash 1061 to the clock domain of cache controller 112.

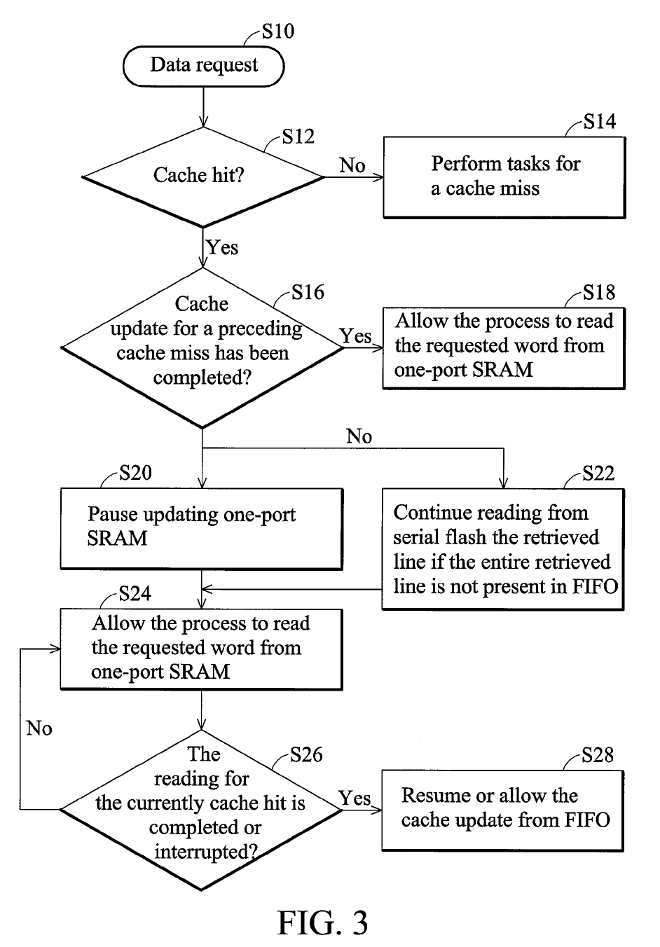

FIG. 3 is a flowchart of operation of the computer system in FIG. 2. In step S 14, following step S10 and a decision in step S12, response to a cache miss includes, but is not limited to, sending a requested word from FIFO 1101 to processor 102 and updating one-port SRAM 1081 using the line in FIFO 1101. In step S18, following step 10 and the two decisions in steps S12 and S16, processor 102 is allowed to read the requested word from one-port SRAM 1081 when the cache read for the current cache hit does not conflict with the cache update for any preceding cache miss. Details of step S18 are omitted herefrom, having been detailed previously. If, in step S16, a cache hit occurs before the cache update for a preceding cache miss is complete, steps S20 and S22 proceed. According to an embodiment of the invention, a cache hit is prioritized higher than a cache miss even if the cache miss occurs earlier and corresponding tasks have -not been completed. To allow processor 102 to read the currently requested word from one-port SRAM 1081, update of one-port SRAM 1081 is paused or prevented in step S20 such that one-port SRAM 1081 is available for a cache read in step S24. Concurrently, if the entire retrieved line for the preceding cache miss has not been stored in FIFO 1101, reading of retrieved line from serial flash 1061 continues. Processor 102 can read one-port SRAM 1081 in step S24 concurrent with FIFO 1101 receiving the retrieved line. When processor 102 reading one-port SRAM 1081 is interrupted or completed (yes in step S26), update of one-port SRAM 1081 is resumed or allowed as shown in step S28.

Referring to FIG. 1, in addition to buffering the retrieved line containing the word requested by processor 102, buffer 110 can also retrieve data from main memory 106 when cache memory 108 requires no current update. Once the line containing the requested word for a subsequent cache miss is present in buffer 110, cache controller 112 directs immediate update of cache memory 108 by the line in buffer 110 without requiring the time to fetch the line from low-speed main memory 106, such that processor 102 promptly receives the requested word. There is high probability that a word currently required by processor 102 is adjacent to the previously requested word, in view of their addresses in main memory 106. Thus, the most likely line in main memory 106 for a next cache miss is that successive to the line most recently retrieved from main memory 106 for a previous cache miss. Accordingly, the line or lines successive to the line most recently retrieved from main memory 106 for a previous cache update are preferably pre-fetched and buffered in buffer 110.

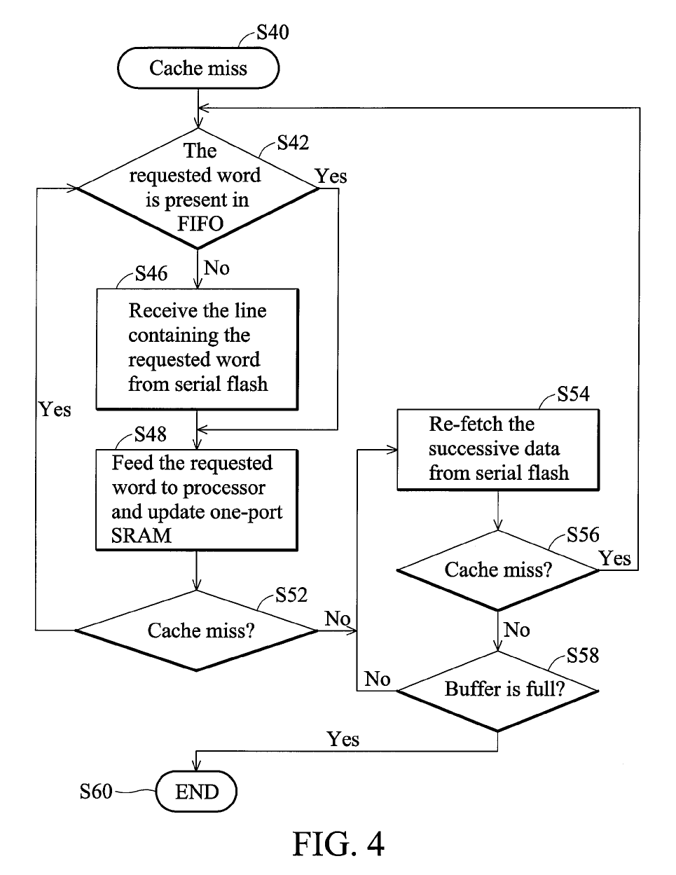

FIG. 4 is a flowchart according to one embodiment of the invention, detailing the operations for a cache miss. With reference to the computer system in FIG. 2, in which FIFO 1101 may buffer a line successive to the line for a previous cache miss. Every time when a cache miss occurs (in step S40, S52, or S56), it is determined whether the requested word is present in FIFO 1101 (as shown in step S42), by comparing the address information of the requested word with the FIFO occupation status indicated by write pointer, wr_ptr[2:0]. If so, the requested word in FIFO 1101 is forwarded to processor 102, and, at the same time, the line containing the requested word, if the line is ready in FIFO 1101, is used to update one-port SRAM 1081 (in step 48). If the requested word is not present in FIFO 1101 (no in step S42), cache controller 112 sends retrieval request 1004 and, responsively, serial flash 1061 provides the line containing the requested word to FIFO 1101 (in step S46). Step 48 is then performed, forwarding the requested word to processor 102 when the requested word is present in FIFO 1101, and updating one-port SRAM 1081 when the line is present in FIFO 1101. Cache update by FIFO 1101 also clears or makes available for further storage at least one line therein. After a cache update, while no subsequent cache miss occurs (no in step S52), FIFO 1101 is ready and available to pre-fetch data from serial flash 1061 (in step S54). According to the address in serial flash 1061, the pre-fetched data must be successive to the line for a previous cache miss. Data pre-fetching continues if no subsequent cache miss occurs (no in step S56) and FIFO 1101 is not full (no in step S58). Step S42 is executed if a cache miss occurs during data retrieving (yes in step S56). Once FIFO 1101 is full (yes in step S60), FIFO 1101 stores the line or lines successive to the line for a previous cache miss.

Here, a word may be one byte or several bytes. While utilizing a one-port SRAM is more economical and preferable to utilizing a two-port SRAM, the disclosure is not limited thereto. The main memory can be DRAM, flash memory, hard disk, optical disk, or any storage means having an operating speed less than cache memory. Furthermore, the cache system and the main memory may operate in the same clock domain but at different frequencies. It is preferred that the buffer in the embodiment has a capacity not less than a line to prevent data overflow. A computer system according to the invention may be implemented by way of system-on-chip (SOC) technology.

While the invention has been described by way of examples and in terms of preferred embodiment, it is to be understood that the invention is not limited to thereto. To the contrary, it is intended to cover various modifications and similar arrangements (as would be apparent to those skilled in the art). Thus, the scope of the appended claims should be accorded the broadest interpretation so as to encompass all such modifications and similar arrangements.

What is claimed is:

1. A cache memory system, comprising:
a cache controller;
a cache memory coupled to the cache controller for storing lines;
a buffer for buffering first data from a main memory prior to updating the cache memory;
wherein the cache controller is configured to allow a processor to read the cache memory in response to a cache hit before cache update of the cache memory for a previous cache miss has been completed;
wherein the buffer stores no address information of the first data.

2. The cache memory system of claim 1, wherein the buffer comprises at least one line.

3. The cache memory system of claim 2, wherein the buffer comprises lines.

4. The cache memory system of claim 1, wherein, after first data in the buffer is written to the cache memory, the buffer stores second data from a main memory, the address for the second data in the main memory is next to the address for the first data in the main memory.

5. The cache memory system of claim 1, wherein the buffer is a FIFO (first-in-first-out).

6. The cache memory system of claim 5, wherein the buffer is an asynchronous FIFO.

7. The cache memory system of claim 5, wherein grey codes are used to address the FIFO.

8. The cache memory system of claim 1, wherein the cache memory has only one data port.

9. The cache memory system of claim 1, wherein the cache memory is a one-port SRAM.

10. The cache memory system of claim 1, wherein the buffer comprises cells and the cache memory system further comprises a multiplexer to provide the processor content buffered in one of the cells.

11. The cache memory system of claim 1, wherein the buffer has cells and the cache memory system further comprises a multiplexer to provide the cache memory content buffered in one of the cells.

12. A method of operating a cache system with a cache memory, comprising: using a buffer to buffer first data from a main memory prior to writing to the cache memory
in response to a cache hit, reading a word from the cache memory; and
in response to a cache miss, writing the first data from the buffer to the cache memory;
wherein, when the cache hit occurs before the first data is fully written from the buffer to the cache memory, the reading is executed and the writing is paused.

13. The method of claim 12, further comprising:
buffering second data from the main memory after the first data has been completely written to the cache memory;
wherein the address for the second data in the main memory is next to the address for the first data.

14. The method of claim 12, wherein the buffer comprises one line.

15. The method of claim 12, wherein the buffer comprises lines.

16. The method of claim 12, wherein the buffer is a FIFO (first-in-first-out).

17. The method of claim 12, wherein the buffer is an asynchronous FIFO.

18. The method of claim 17, wherein grey codes are used to address the asynchronous FIFO.

19. A computer system, comprising:
a processor;
a cache controller coupled to the processor;
a cache memory coupled to the cache controller for storing lines of words;
a main memory;
a buffer for buffering first data from the main memory prior to writing to the cache memory;
wherein the cache controller is directs the processor to read the cache memory in response to a cache hit, and write the first data from the buffer into the cache memory in response to a cache miss;
wherein the cache controller is further configured to pause the writing and execute the reading when the cache hit occurs before first data is completely written from the buffer to the cache memory.

20. The computer system of claim 19, wherein the buffer is an asynchronous FIFO comprising cells addressed by grey codes.
